(19) United States
(12) Patent Application Publication
(10) Pub. No.: US 2016/0010556 A1
(43) Pub. Date: Jan. 14, 2016

(54) FLUID NOZZLE AND METHOD OF DISTRIBUTING FLUID THROUGH A NOZZLE

(71) Applicant: Delavan, Inc., Des Moines, IA (US)

(72) Inventor: Andy W. Tibbs, Earlham, IA (US)

(21) Appl. No.: 14/328,219

(22) Filed: Jul. 10, 2014

(51) Int. Cl. F02C 7/22

(52) U.S. Cl. CPC F02C 7/22

(57) ABSTRACT

A fluid nozzle includes, a body having an annular cavity that extends out one axial end of the fluid nozzle. At least one port fluidically connects to an annular chamber of the annular cavity and the annular cavity is defined between a radially inner surface of the body and a radially outer surface of the body. A first portion of the radially outer surface has a first radial dimension smaller than a greatest radial dimension of the at least one port and a second portion of the radially outer surface further from the annular chamber than the first portion has a second radial dimension greater than the first radial dimension and so forth.

### BACKGROUND OF THE INVENTION

Fuel nozzles are employed to inject fuel into machines such as gas turbine engines, for example. Uniform distribution of the fuel flow before it is discharged from the nozzle helps even out temperature variations during combustion. Although conventional fuel nozzles serve the purpose for which they were designed, devices and methods that promote even greater uniformity of flow distribution of fuel are always of interest to those that practice in the art.

### BRIEF DESCRIPTION OF THE INVENTION

Disclosed herein is a fluid nozzle. The fluid nozzle includes, a body having an annular cavity that extends out one axial end of the fluid nozzle. At least one port fluidically connects to an annular chamber of the annular cavity and the annular cavity is defined between a radially inner surface of the body and a radially outer surface of the body. A first portion of the radially outer surface has a first radial dimension smaller than a greatest radial dimension of the at least one port and a second portion of the radially outer surface further from the annular chamber than the first portion has a second radial dimension greater than the first radial dimension.

Further disclosed is a method of distributing fluid flow through a nozzle. The method includes flowing fluid through at least one port into an annular cavity in a body in a substantially axial direction, impinging the flowing fluid against a radially outer surface of the annular cavity, redirecting the flowing fluid to flow substantially radially, and redirecting the flowing fluid to again flow substantially axially.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 depicts a partial side cross sectional view of a fuel nozzle disclosed herein;

FIG. 2 depicts a partial perspective view of the fuel nozzle of FIG. 1 with a portion shown as partially transparent;

FIG. 3 depicts a partial side cross sectional view of an alternate embodiment of a fuel nozzle disclosed herein; and

FIG. 4 depicts a partial side cross sectional view of another alternate embodiment of a fuel nozzle disclosed herein.

### DETAILED DESCRIPTION OF THE INVENTION

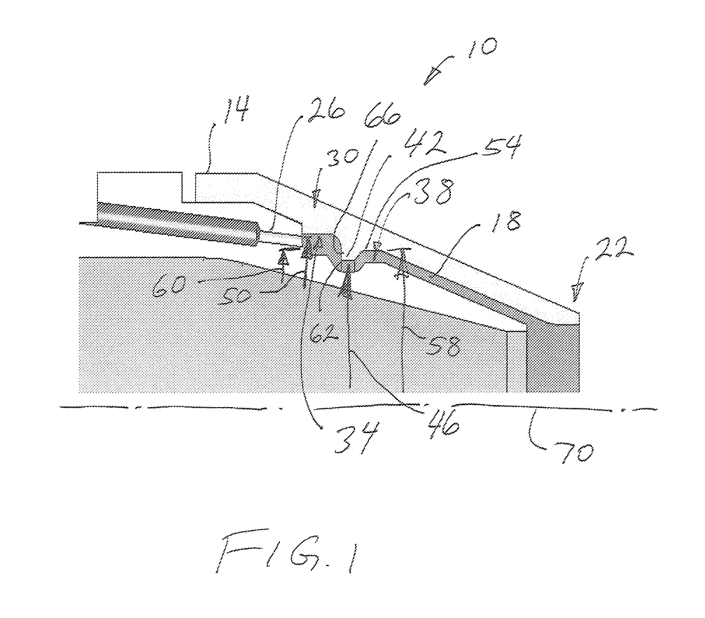

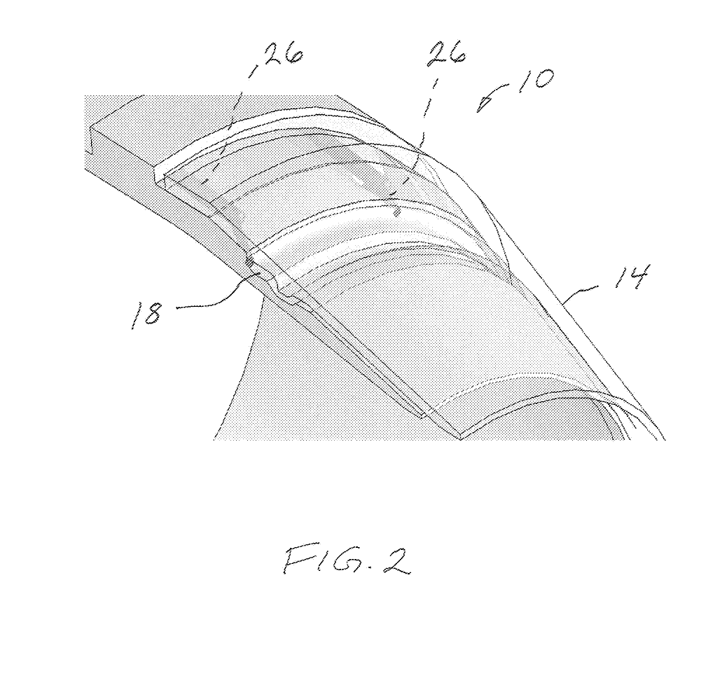

Referring to FIGS. 1 and 2, an embodiment of a fluid nozzle disclosed herein is illustrated at 10. The fluid nozzle 10 includes a body 14 having an annular cavity 18 that extends out one axial end 22 thereof and at least one port 26 fluidically connected to an annular chamber 30 of the annular cavity 18. The at least one port 26 is preferred to be aligned angular to an axis of the nozzle 10 and located near tangent a radially outer surface 34. The annular cavity 18 is defined between the radially outer surface 34 and a radially inner surface 38. A first portion 42 of the radially outer surface 34 has a first radial dimension 46 that is smaller than a greatest outer radial dimension 50 of the at least one port 26 and a second portion 54 of the radially outer surface 34 further from the annular chamber 30 than the first portion 42 that has a second radial dimension 58 that is greater than the first radial dimension 46. Additionally, in the illustrated embodiment the first radial dimension 46 is smaller than a smallest radial dimension 60 of the at least one port 26.

Also in the illustrated embodiment the radially outer surface 34 includes an approximately sharp (0.000-0.005 radius or edge break) dimensional transition 62 between the annular chamber 30 and the first portion 54. The approximately sharp dimensional transition 62 shown includes a 90 degree corner thereby partially defining a wall 66 of the radially outer surface 34 that is perpendicular to an axis 70 of the fluid nozzle 10.

The foregoing structure promotes uniformity of distribution of fluid flowing through the fluid nozzle 10. Stated another way, the disparity in volumetric fluid flow measured perimetrically around the annular cavity 18 is less than it would be were the first portion 42 not present or not configured as disclosed herein. As such, regardless of how many of the at least one ports 26 are employed, the distribution of fluid leaving the annular cavity 18 can be substantially evenly distributed about the perimeter of the annular cavity 18. This in part is due flowing fluid through the at least one port 26 and into the annular cavity 18 in a substantially axial direction. Impinging the flowing fluid against the radially outer surface 34 thereby redirecting the flowing fluid to flow substantially radially inwardly. Then redirecting the flowing fluid again so that flow is substantially oriented axially again. Each of these redirections tends to even out distribution of volumetric flow around the perimeter of the annular cavity 18. It should be noted that the features disclosed herein that reduce disparity in volumetric fluid flow also improve the thoroughness of mixing of different fluids that may be introduced through the ports 26 into to the annular cavity 18. These features also allow the annular cavity 18 to have a shorter axial length for a given amount of mixing or evening of fluid distribution.

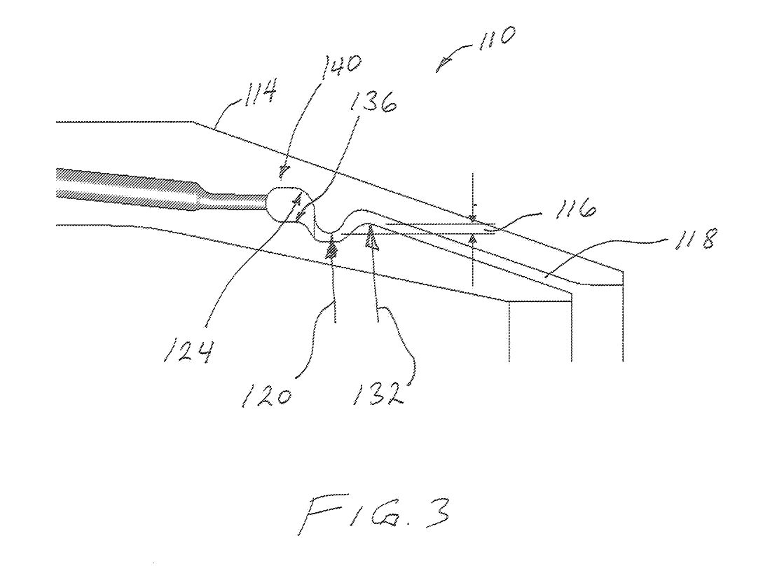

Referring to FIG. 3, an alternate embodiment of a fluid nozzle disclosed herein is illustrated at 110. The fluid nozzle 110 has similarities to that of the fluid nozzle 10. As such, primarily the differences between the two nozzles 10 and 110 will be described in detail herein. The fluid nozzle 110 includes a body 114 that is made of a single piece with an annular cavity 118 therein. This construction allows there to be an overlap dimension 116 defined between a first radial dimension 120 on a radially outer surface 124 of the annular cavity 118 and a second radial dimension 132 on a radially inner surface 136, with the second radial dimension 132 being positioned further from an annular chamber 140 of the annular cavity 118 than the first radial dimension 120. If the body 114 were made of two pieces, such as the body 14 may be, wherein the radially outer surface 124 were on one piece separate while the radially inner surface 136 is on another piece, axially assembling the two pieces together would be prevented because of the interference defined by the overlap dimension 116. Making the body 114 of a single piece of material is possible by use of manufacturing methods such as loss core technology or additive manufacturing, which is sometimes referred to as three-dimensional printing. Although only one of the overlapping dimensions 116 is illustrated in the embodiments herein, these manufacturing techniques allow for more than one of the overlapping dimensions 116 to exist in a single part.

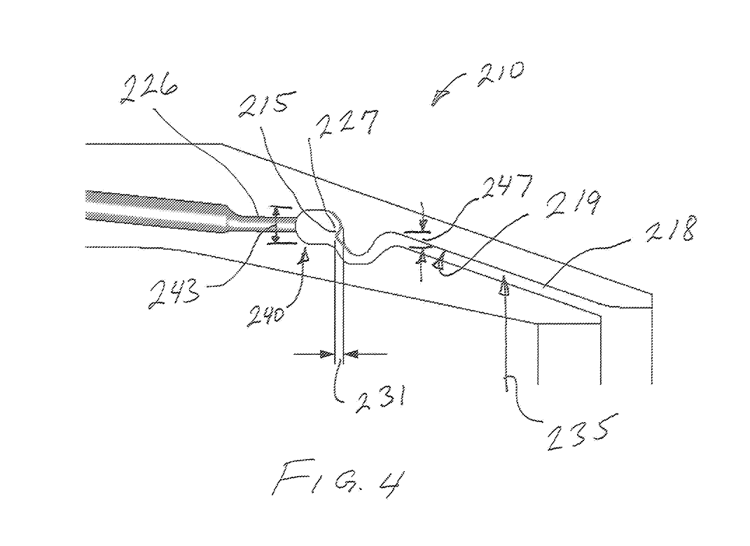

Referring to FIG. 4, yet another embodiment of a fluid nozzle disclosed herein is illustrated at 210. The fluid nozzle 210 includes a section 215 of a radially outer surface 219 that faces radially outwardly, unlike the balance of the radially outer surface 219. The section 215 allows fluid from the at least one port 226 to pool within the recess 227 defined by the shape of the radially outer surface 219. A depth of the recess 227 is designated by dimension 231. This pooling of fluid facilitates uniform thickness of fluid flowing from the recess 227 as the recess 227 essentially overflows. This overflowing of the recess 227 may allow for substantially uniform volumetric flow rates at all points around a circumference of an annular cavity 218, for example.

The fluid nozzle 210 includes other features that are also common to the nozzles 10 and 110. For example, majority of the annular cavity 218 has a substantially frustoconical shape with radial dimensions 235 of the annular cavity 218 being smaller further from an annular chamber 240 of the annular cavity 218. Additionally, the annular cavity 218 has a first annular dimension 243 nearer to the annular chamber 240 that is greater than a second annular dimension 247 thereof that is further from the annular chamber 240.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A fluid nozzle, comprising a body having an annular cavity that extends out one axial end of the fluid nozzle, at least one port fluidically connected to an annular chamber of the annular cavity, the annular cavity being defined between a radially inner surface of the body and an radially outer surface of the body, a first portion of the radially outer surface having a first radial dimension smaller than a greatest radial dimension of the at least one port and a second portion of the radially outer surface further from the annular chamber than the first portion having a second radial dimension greater than the first radial dimension.

2. The fluid nozzle of claim 1, wherein the radially outer surface includes at least one approximately sharp dimensional transition.

3. The fluid nozzle of claim 1, wherein the first radial dimension is smaller than a smallest radial dimension of the at least one port.

4. The fluid nozzle of claim 1, wherein a wall of the radially outer surface is substantially perpendicular to an axis of the fluid nozzle.

5. The fluid nozzle of claim 1, wherein a wall of the radially outer surface is facing radially outwardly.

6. The fluid nozzle of claim 1, wherein a majority of the annular cavity has a generally frustoconical shape.

7. The fluid nozzle of claim 6, wherein radial dimensions of the annular cavity are smaller further from the dead end.

8. The fluid nozzle of claim 1, wherein a radial dimension of the annular cavity is greater nearer to the annular chamber than further from the annular chamber.

9. A method of distributing fluid flow through a nozzle, comprising:
flowing fluid through at least one port into an annular cavity in a body in a substantially axial direction;
impinging the flowing fluid against a radially outer surface of the annular cavity;
redirecting the flowing fluid to flow substantially radially; and
redirecting the flowing fluid to flow substantially axially again.

10. The method of distributing fluid flow through a nozzle of claim 9, wherein the substantially radial direction is radially inwardly.

11. The method of distributing fluid flow through a nozzle of claim 9, further comprising redirecting the flowing fluid to include a radially outwardly component after having redirected the flowing fluid to flow substantially axially.

12. The method of distributing fluid flow through a nozzle of claim 9, further comprising decreasing disparities in volumetric flow rates of flowing fluid measured perimetrically around the annular cavity.

13. The method of distributing fluid flow through a nozzle of claim 9, further comprising plurality of redirecting flowing fluid in series of occurrence.
